(19) United States
(12) Patent Application Publication
(10) Pub. No.: US 2007/0052342 A1
(43) Pub. Date: Mar. 8, 2007

(54) Light-emitting device

(75) Inventors: Masatsugu Masuda, Higashihiroshima-shi (JP); Masaaki Katoh, Osaka-shi (JP); Kazuhiko Inoguchi, Nara-shi (JP); Hiroshi Umeda, Kitakatsuragi-gun (JP); Yuhichi Memida, Kitakatsuragi-gun (JP); Takashi Oouchida, Kitakatsuragi-gun (JP); Yuhsuke Fujita, Higashihiroshima-shi (JP); Masatoshi Omoto, Osaka-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/515,512

(22) Filed: Aug. 31, 2006

(30) Foreign Application Priority Data
Sep. 1, 2005 (JP) 2005-253468
Nov. 8, 2005 (JP) 2005-323499
Dec. 21, 2005 (JP) 2005-368391
Aug. 10, 2006 (JP) 2006-218498
Aug. 10, 2006 (JP) 2006-218502

(51) Int. Cl. H01J 1/62

(52) U.S. Cl. 313/487; 313/499

(57) ABSTRACT

A light-emitting device includes a light-emitting element emitting primary light and a wavelength conversion portion absorbing a part of the primary light and emitting secondary light having a wavelength equal to or longer than the wavelength of the primary light. The wavelength conversion portion includes a plurality of green or yellow light-emitting phosphors and a plurality of red light-emitting phosphors. The green or yellow light-emitting phosphor is implemented by at least one selected from a specific europium (II)-activated silicate phosphor (A-1) and a specific cerium (III)-activated silicate phosphor (A-2). The red light-emitting phosphor is implemented by a specific europium (II)-activated nitride phosphor (B). The light-emitting device emitting white light at efficiency and color rendering property higher than in a conventional example can thus be provided.

This nonprovisional application is based on Japanese Patent Applications Nos. 2005-253468, 2005-323499, 2005-368391, 2006-218498, and 2006-218502 filed with the Japan Patent Office on Sep. 1, 2005, Nov. 8, 2005, and Dec. 21, 2005, Aug. 10, 2006, and Aug. 10, 2006, respectively, the entire contents of which are hereby incorporated by reference.

### FIELD OF THE INVENTION

The present invention relates to a light-emitting device attaining high efficiency and high color rendering property, that includes a light-emitting element emitting primary light and a wavelength conversion portion absorbing the primary light and emitting secondary light.

### DESCRIPTION OF THE BACKGROUND ART

A light-emitting device including combination of a light-emitting element emitting primary light and a wavelength conversion portion absorbing the primary light and emitting secondary light has attracted attention as the next-generation light-emitting device expected to achieve low power consumption, small size, high luminance, and color reproduction of a broader range, and research and development of such a light-emitting device has actively been conducted. Light in a range from ultraviolet to blue having a long wavelength, that is, a wavelength from 380 nm to 480 nm, is normally employed as the primary light emitted from the light-emitting element. In addition, various phosphors suitable for applications are used in the wavelength conversion portion.

In recent years, not only efficiency (brightness) but also high color rendering property (color reproduction property) of the light-emitting device of this type have also been demanded. At present, a light-emitting device including combination of a light-emitting element emitting blue light (peak wavelength: around 450 nm) and a wavelength conversion portion using a cerium (III)-activated (Y,Gd)₃(Al,Ga)₅O₁₂ phosphor or a europium (II)-activated (Sr,Ba,Ca)₂SiO₄ phosphor, that is excited by the blue light and emits yellow light, has mainly been used as the light-emitting device exhibiting white emission.

Such a light-emitting device, however, currently attains a general color rendering index (Ra) around 70, and a special color rendering index (R9), indicating how red color in particular is exhibited, around −40, which is extremely poor. It is quite inappropriate to employ such a light-emitting device as an illumination source. Therefore, when the light-emitting device of this type is intended to serve as the illumination source, improvement in the color rendering property (color reproduction property) has urgently been demanded.

Moreover, normally, an illumination source attaining color rendering AAA (the standard defined under JIS-Z9112) representing the color rendering property grade is employed as the illumination source in an art museum, a museum and a color printing office. Particularly, in a fluorescent lamp for an art museum and a museum that attains color rendering AAA, various measures (forming of an ultraviolet absorbing film) for absorbing ultraviolet ray of a long wavelength (for example, 365 nm) emitted from the fluorescent lamp have been taken. Therefore, development of a light-emitting device of this type adapted to color rendering AAA with a simplified structure and long life has urgently been demanded.

International Publication WO2001/24229 discloses a light-emitting device of this type, paying attention to the color rendering property (color reproduction property). According to International Publication WO2001/24229, when SrGa₂S₄.Eu²⁺ and SrS:Eu²⁺ are mainly used as a green phosphor and a red light-emitting phosphor respectively, color rendering index (Ra) of 70 to 90 can be achieved. On the other hand, thiogallate and sulfide are chemically unstable, and in particular, the sulfide tends to decompose under radiation of the ultraviolet.

According to EP1433831, a red light-emitting nitride phosphor such as Ca_{1.97}Si₅N₈:Eu_{0.03} is used as a yellow-emission YAG:Ce phosphor, so that general color rendering index (Ra) of 75 to 90 can be obtained, and a light-emitting device emitting reddish white light can be provided by increasing the value of special color rendering property (R9). On the other hand, combination of the light-emitting element emitting blue light with the yellow-emission YAG:Ce phosphor and the red-emission Eu (II)-activated nitride phosphor (that is, Ca_{1.97}Si₅N₈:Eu_{0.03}, LₓM_{y}N_{(2/3x+4/3y)}:Z) is poor in an emission component in a green region, and it is difficult to attain high general color rendering index (Ra) in a stable manner. In addition, brightness of the light-emitting device is also significantly lowered due to addition of the red light-emitting phosphor (Ca_{1.97}Si₅N₈:Eu_{0.03}).

None of these documents mentions adaptation to the color rendering AAA. That is, as described above, under the color rendering AAA standard, minimum values of not only Ra and R9 but also R10, R11, R12, R13, R14, and R15 are defined.

In addition, in recent years, light emission from the light-emitting device at various correlated color temperatures (warm white to incandescent lamp color) has been desired, because of various color senses. On the other hand, it is extremely difficult to obtain light at the correlated color temperature not higher than 4000K with the light-emitting device including combination of a light-emitting element emitting blue light described above with a wavelength conversion portion employing a cerium (III)-activated (Y,Gd)₃(Al,Ga)₅O₁₂ phosphor or a europium (II)-activated (Sr,Ba,Ca)₂SiO₄ phosphor. For example, if the correlated color temperature of 3000K is to be reproduced, deviation (duv) which will be described later attains to around +0.04. Namely, very yellowish white light is merely obtained, and it is difficult to obtain clear light at the correlated color temperature of 3000K. Therefore, as to the light-emitting device of this type, in order to meet the demand of the market, a product capable of emitting clear light at low color temperature has also urgently been demanded.

As to the light-emitting device of this type, according-to US2005/0001225A1, a (Ca_{0.15}Eu_{0.06})(Si,Al)₁₂(O,N)₁₆ phosphor has an excitation peak in a range from 350 to 500 nm, and an emission peak is located in a range from 550 to 650 nm. In addition, US2005/0001225A1 describes excitation and light emission properties of various phosphors. US2005/0001225A1, however, basically pays attention to improvement in the color rendering property of the red color, and it is silent about white light at low correlated color temperature.

US2003/0030368A1 discloses a color coordinate of a mixture of a blue LED (wavelength 460 nm) and a GO-phosphor that includes GO-phosphor at a proportion of 0.5 to 9% (europium (II)-activated sialon emitting yellow-orange light). According to US2003/0030368A1, a colored LED of a desired color is realized, and the color coordinate on a connecting line from blue, pink to yellow-orange is achieved. US2003/0030368A1, however, is again silent about white light at specific low correlated color temperature.

Japanese Patent Laying-Open No. 2001-127346 discloses combination of a blue light-emitting element, a yellow light-emitting phosphor (YAG phosphor) and a red light-emitting phosphor (CuS phosphor: emission around a wavelength of 630 nm), and the combination can improve the color rendering property. In addition, according to this publication, as light of three colors, i.e., blue, yellow and red, is included, color tone is broader. On the other hand, the CuS phosphor tends to react with moisture and is susceptible to oxidation and chemically unstable. In addition, Japanese Patent Laying-Open No. 2001-127346 does not mention white light at specific low correlated color temperature.

Japanese Patent Laying-Open No. 2005-109085 discloses a white light-emitting diode including combination of an LED chip emitting ultraviolet ray with an α-silicon nitride phosphor and an oxide phosphor emitting yellow visible light and emitting blue visible light respectively, as a result of excitation by the ultraviolet emitted from the LED chip. Even with Japanese Patent Laying-Open No. 2005-109085, it is difficult to obtain a product attaining low correlated color temperature, as in the conventional white light-emitting device.

Meanwhile, if the blue light-emitting element (peak wavelength around 450 nm) and the cerium (III)-activated (Y,Gd)₃(Al,Ga)₅O₁₂ phosphor excited by the blue light and emitting yellow light are employed, white light can be emitted at high efficiency only when the peak wavelength of the primary light from the light-emitting element is around 450 nm. Namely, the light-emitting device cannot emit white light at high efficiency across the entire wavelength regions where the peak wavelength of the primary light is in a range from 380 nm to 480 nm.

### SUMMARY OF THE INVENTION

The present invention was made to solve the above-described problems. An object of the present invention is to provide a light-emitting device attaining high efficiency and high color rendering property (particularly, attaining color rendering AAA) by employing a specific phosphor emitting light at high efficiency by receiving light from a semiconductor light-emitting element in a range from 430 to 480 nm or in a range from 380 to 430 nm.

In addition, another object of the present invention is to provide a light-emitting device emitting white light at high efficiency and low correlated color temperature by employing a specific phosphor emitting light at high efficiency by receiving light from a semiconductor light-emitting element in a range from 430 to 480 nm or in a range from 380 to 430 nm.

A light-emitting device according to the present invention includes a light-emitting element emitting primary light, and a wavelength conversion portion absorbing a part of the primary light and emitting secondary light having a wavelength equal to or longer than wavelength of the primary light, and including a plurality of green or yellow light-emitting phosphors and a plurality of red light-emitting phosphors. The green or yellow light-emitting phosphor included in the wavelength conversion portion of the present invention is implemented by at least one selected from a europium (II)-activated silicate phosphor substantially expressed as General Formula (A-1): 2(M₁₋ₐEuₐ)O.SiO₂ (in General Formula (A-1), MI represents at least one element selected from among Mg, Ca, Sr, and Ba, and relation of 0.005≦a≦0.10 is satisfied) and a cerium (III)-activated silicate phosphor substantially expressed as General Formula (A-2): MII₃(MIII_{1-b}Ce_{b})₂(SiO₄)₃ (in General Formula (A-2), MII represents at least one element selected from among Mg, Ca, Sr, and Ba, MIII represents at least one element selected from among Al, Ga, In, Sc, Y, La, Gd, and Lu, and relation of 0.005≦b≦0.5 is satisfied). The red light-emitting phosphor included in the wavelength conversion portion of the present invention is implemented by a europium (II)-activated nitride phosphor substantially expressed as General Formula (B): (MIV_{1-c}Eu_{c})MVSiN₃ (in General Formula (B), MIV represents at least one element selected from among Mg, Ca, Sr, and Ba, MV represents at least one element selected from among Al, Ga, In, Sc, Y, La, Gd, and Lu, and relation of 0.001≦c≦0.05 is satisfied).

According to such a light-emitting device of the present invention, light emission from the light-emitting element is efficiently absorbed and high-efficiency white light is emitted. In addition, white light excellent in color rendering property, particularly, white light significantly excellent in color rendering property satisfying color rendering AAA, or non-yellowish, clear white light at a low correlated color temperature having less blackbody locus deviation can be obtained.

Here, preferably, the light-emitting element is implemented by a gallium nitride (GaN)-based semiconductor emitting the primary light having a peak wavelength in a range from 430 nm to 480 nm (more preferably in a range from 460 to 480 nm).

In addition, the present invention provides a light-emitting device including a light-emitting element emitting primary light, and a wavelength conversion portion absorbing a part of the primary light and emitting secondary light having a wavelength equal to or longer than wavelength of the primary light, and including a plurality of green or yellow light-emitting phosphors, a plurality of red light-emitting phosphors and a plurality of blue light-emitting phosphors. The green or yellow light-emitting phosphor included in the wavelength conversion portion of the present invention is implemented by at least one selected from a europium (II)-activated silicate phosphor substantially expressed as General Formula (A-1): 2(MI₁₋ₐEuₐ)O.SiO₂ (in General Formula (A-1), MI represents at least one element selected from among Mg, Ca, Sr, and Ba, and relation of 0.005≦a≦0.10 is satisfied) and a cerium (III)-activated silicate phosphor substantially expressed as General Formula (A-2): MII₃(MIII_{1-b}Ce_{b})₂(SiO₄)₃ (in General Formula (A-2), MII represents at least one element selected from among Mg, Ca, Sr, and Ba, MIII represents at least one element selected from among Al, Ga, In, Sc, Y, La, Gd, and Lu, and relation of 0.005≦b≦0.5 is satisfied). The red light-emitting phosphor included in the wavelength conversion portion of the present invention is implemented by a europium (II)-activated nitride phosphor substantially expressed as General Formula (B): (MIV_{1-c}Eu_{c})MVSiN₃ (in General Formula (B), MIV represents at least one element selected from among Mg, Ca, Sr, and Ba, MV represents at least one element selected from among Al, Ga, In, Sc, Y, La, Gd, and Lu, and relation of 0.001≦c≦0.05 is satisfied). The blue light-emitting phosphor included in the wavelength conversion portion of the present invention is implemented by at least one selected from a europium (II)-activated halophosphate phosphor substantially expressed as General Formula (C-1): (MVI,Eu)₁₀(PO₄)₆.Cl₂ (in General Formula (C-1), MVI represents at least one element selected from among Mg, Ca, Sr, and Ba), a europium (II)-activated aluminate phosphor substantially expressed as General Formula (C-2): d(MVII,Eu)O.eAl₂O₃ (in General Formula (C-2), MVII represents at least one element selected from among Mg, Ca, Sr, Ba, and Zn, and relation of d>0, e>0, and 0.1≦d/e≦1.0 is satisfied), and a europium (II)- and manganese-activated aluminate phosphor substantially expressed as General Formula (C-3): f(MVII,Euₕ,Mnᵢ)O.gAl₂O₃ (in General Formula (C-3), MVII represents at least one element selected from among Mg, Ca, Sr, Ba, and Zn, and relation of f>0, g>0, 0.1i≦f/g≦1.0, and 0.001≦i/h≦0.2 is satisfied).

According to such a light-emitting device of the present invention as well, light emission from the light-emitting element is efficiently absorbed and high-efficiency white light is emitted. In addition, white light excellent in color rendering property, particularly, white light significantly excellent in color rendering property satisfying color rendering AAA, or non-yellowish, clear white light at a low correlated color temperature having less blackbody locus deviation can be obtained.

Here, preferably, the light-emitting element is implemented by a gallium nitride (GaN)-based semiconductor emitting the primary light having a peak wavelength in a range from 380 nm to 430 nm.

In the light-emitting device of the present invention, preferably, the europium (II)-activated nitride phosphor, in which MV in General Formula (B) is at least one element selected from among Al, Ga and In, is used as the red light-emitting phosphor.

In addition, in the light-emitting device of the present invention, preferably, the europium (II)-activated silicate phosphor and the cerium (III)-activated silicate phosphor serve as the green light-emitting phosphor. Here, the green light-emitting phosphor composed of the europium (II)-activated silicate is such that MI in General Formula (A-1) includes at least Ba and relation of Ba≧0.5 is satisfied.

In the light-emitting device of the present invention, preferably, the green light-emitting phosphor composed of the cerium (III)-activated silicate substantially expressed in General Formula (A-2) is used as the green or yellow light-emitting phosphor. Here, more preferably, MII in General Formula (A-2) is at least one element selected from Mg and Ca.

If the europium (II)-activated silicate phosphor and the cerium (III)-activated silicate phosphor serve as the green light-emitting phosphor in the light-emitting device of the present invention, the primary light emitted by the light-emitting element preferably has a peak wavelength in a range from 460 nm to 480 nm.

Here, preferably, the light-emitting device according to the present invention (1) attains correlated color temperature in a range from 5700K to 7100K, general color rendering index of at least 90, and special color rendering indices R9 to R15 of at least 90, or (2) attains correlated color temperature in a range from 4600K to 5400K, general color rendering index of at least 90, and special color rendering indices R9 to R15 of at least 90.

In the light-emitting device according to the present invention, preferably, the yellow light-emitting phosphor composed of the europium (II)-activated silicate, in which MI in General Formula (A-1) includes at least Sr and relation of Sr≧0.5 is satisfied, is used as the green or yellow light-emitting phosphor.

Here, preferably, the light-emitting device according to the present invention emits white light at a correlated color temperature not higher than 4000K.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows emission spectrum distribution of a light-emitting device (Example 1) representing a preferred example of the present invention.

FIG. 2 is a schematic longitudinal cross-sectional view of a main portion of a light-emitting device of Example 1 of the present invention.

FIG. 3 is a schematic longitudinal cross-sectional view of a main portion of a light-emitting device of Example 3 of the present invention.

FIG. 4 is a schematic longitudinal cross-sectional view of a main portion of a light-emitting device of Example 6 of the present invention.

FIG. 5 shows emission spectrum distribution of a light-emitting device (Example 10) representing a preferred example of the present invention.

### DESCRIPTION OF THE PREFERRED EMBODIMENTS

A light-emitting device according to the present invention basically includes a light-emitting element emitting primary light, and a wavelength conversion portion absorbing a part of the primary light and emitting secondary light having a wavelength equal to or longer than wavelength of the primary light. The wavelength conversion portion in the light-emitting device of the present invention includes a plurality of green or yellow light-emitting phosphors and a plurality of red light-emitting phosphors.

The green or yellow light-emitting phosphor used in the wavelength conversion portion in the light-emitting device of the present invention is implemented by at least one of (A-1) europium (II)-activated silicate phosphor and (A-2) cerium (III)-activated silicate phosphor below. Namely, any one of (A-1) europium (II)-activated silicate phosphor and (A-2) cerium (III)-activated silicate phosphor alone can preferably be used in combination with the red light-emitting phosphor. Alternatively, (A-1) europium (II)-activated silicate phosphor and (A-2) cerium (III)-activated silicate phosphor may naturally be mixed and combined with the red light-emitting phosphor for use.

It is noted that (A-1) europium (II)-activated silicate phosphor among the green or yellow light-emitting phosphors in the present invention may be employed as the green light-emitting phosphor or the yellow light-emitting phosphor depending on its composition as will be described later. The “green or yellow light-emitting phosphor” in the present invention is collectively directed to use as the green light-emitting phosphor (use of (A-1) europium (II)-activated silicate phosphor alone having a specific composition, use of (A-2) cerium (III)-activated silicate phosphor alone, and use thereof in combination) and use as the yellow light-emitting phosphor (use of (A-1) europium (II)-activated silicate phosphor alone having a specific composition).

(A-1) Europium (II)-Activated Silicate Phosphor

The europium (II)-activated silicate phosphor is substantially expressed as
2(MI₁₋ₐEuₐ)O.SiO₂. General Formula (A-1)
In General Formula (A-1), MI represents an alkali earth metal, and represents at least one element selected from among Mg, Ca, Sr, and Ba. Preferably, MI is at least one element selected from Sr and Ba, among the elements above.

The europium (II)-activated silicate phosphor may be used as the green light-emitting phosphor when MI in General Formula (A-1) includes at least Ba and relation of Ba≧0.5 is satisfied. Alternatively, the europium (II)-activated silicate phosphor may be used as the yellow light-emitting phosphor when MI in General Formula (A-1) includes at least Sr and relation of Sr≧0.5 is satisfied.

In General Formula (A-1) above, the value of a satisfies relation of 0.005≦a≦0.10 and preferably satisfies relation of 0.01≦a≦0.05. If the value of a is smaller than 0.005, sufficient brightness is not obtained. On the other hand, if the value of a exceeds 0.10, brightness significantly lowers.

Specific examples of (A-1) europium (II)-activated silicate phosphor include 2(Ba_{0.60}Sr_{0.38}Eu_{0.02})O.SiO₂, 2(Sr_{0.80}Ba_{0.18}Eu_{0.02})O.SiO₂, 2(Ba_{0.55}Sr_{0.43}Eu_{0.02})O.SiO₂, 2(Ba_{0.83}Sr_{0.15}Eu_{0.02})O.SiO₂, 2(Sr_{0.78}Ba_{0.20}Eu_{0.02})O.SiO₂, 2(Ba_{0.60}Sr_{0.38}Ca_{0.01}Eu_{0.01})O.SiO₂, 2(Ba_{0.820}Sr_{0.165}Eu_{0.015})O.SiO₂, 2(Ba_{0.55}Sr_{0.42}Eu_{0.03})O.SiO₂, 2(Sr_{0.75}Ba_{0.21}Ca_{0.01}Eu_{0.03})O.SiO₂, 2(Sr_{0.650}Ba_{0.315}Ca_{0.020}Eu_{0.015})O.SiO₂, 2(Sr_{0.56}Ba_{0.40}Eu_{0.04})O.SiO₂, 2(Sr_{0.93}Ba_{0.05}Eu_{0.02})O.SiO₂, 2(Sr_{0.900}Ba_{0.075}Ca_{0.010}Eu_{0.015})O.SiO₂, 2(Sr_{0.90}Ba_{0.07}Ca_{0.01}Eu_{0.02})O.SiO₂, 2(Sr_{0.91}Ba_{0.05}Ca_{0.02}Eu_{0.02})O.SiO₂, 2(Sr_{0.90}Ba_{0.07}Eu_{0.03})O.SiO₂, 2(Sr_{0.85}Ba_{0.12}Ga_{0.01}Eu_{0.02})O.SiO₂, 2(Sr_{0.88}Ba_{0.10}Eu_{0.02})O.SiO₂, 2(Sr_{0.85}Ba_{0.13}Eu_{0.02})O.SiO₂, and the like, however, it is naturally not limited as such.

(A-2) Cerium (III)-Activated Silicate Phosphor

The cerium (III)-activated silicate phosphor is substantially expressed as
MII₃(MIII_{1-b}Ce_{b})₂(SiO₄)₃. General Formula (A-2)
The cerium (III)-activated silicate phosphor may be used as the green light-emitting phosphor.

In General Formula (A-2), MII represents an alkali earth metal, and represents at least one element selected from among Mg, Ca, Sr, and Ba. Preferably, MII is at least one element selected from Mg and Ca, among the elements above.

In General Formula (A-2) above, MIII represents a trivalent metal element, and represents at least one element selected from among Al, Ga, In, Sc, Y, La, Gd, and Lu. MIII is preferably at least one element selected from among In, Sc and Y, among the elements above.

In General Formula (A-2) above, the value of b satisfies relation of 0.005≦b≦0.5 and preferably satisfies relation of 0.01≦b≦0.2. If the value of b is smaller than 0.005, sufficient brightness is not obtained. On the other hand, if the value of b exceeds 0.5, brightness significantly lowers due to concentration quenching or the like.

Specific examples of (A-2) cerium (III)-activated silicate phosphor include Ca₃(Sc_{0.85}Ce_{0.15})₂(SiO₄)₃, (Ca_{0.8}Mg_{0.2})₃(Sc_{0.75}Ga_{0.15}Ce_{0.10})₂(SiO₄)₃, (Ca_{0.9}Mg_{0.1})₃(Sc_{0.90}Ce_{0.10})₂(SiO₄)₃, (Ca_{0.9}Mg_{0.1})₃(Sc_{0.85}Ce_{0.15})₂(SiO₄)₃, (Ca_{0.85}Mg_{0.15})₃(Sc_{0.80}Y_{0.05}Ce_{0.15})₂.(SiO₄)₃, Ca₃(Sc_{0.98}In_{0.01}Ce_{0.01})₂(SiO₄)₃, Ca₃(Sc_{0.995}Ce_{0.005})₂(SiO₄)₃, Ca₃(Sc_{0.63}Y_{0.02}Ce_{0.35})₂(SiO₄)₃, and the like, however, it is naturally not limited as such.

A particle size (average particle size, Blane method) of the green or yellow light-emitting phosphor in the wavelength conversion portion of the light-emitting device of the present invention is not particularly limited either, however, in the case of (A-1) europium (II)-activated silicate phosphor, the particle size is preferably in a range from 6 to 15 μm, and more preferably in a range from 8 to 13 μm. If the particle size of (A-1) europium (II)-activated silicate phosphor is smaller than 6 μm, crystal growth is insufficient and brightness tends to be significantly low. On the other hand, if the particle size exceeds 15 μm, control of sedimentation in a normal resin tends to be difficult. In the case of (A-2) cerium (III)-activated silicate phosphor, the particle size is preferably in a range from 5 to 12 μm, and more preferably in a range from 7 to 10 μm. If the particle size of (A-2) cerium (III)-activated silicate phosphor is smaller than 5 μm, crystal growth is insufficient and brightness tends to be significantly low. On the other hand, if the particles having a particle size exceeding 15 μm are prepared, generation of abnormally grown coarse particles is likely, which is not practical.

The red light-emitting phosphor employed in the wavelength conversion portion in the light-emitting device of the present invention is implemented by (B) europium (II)-activated nitride phosphor below.

(B) Europium (II)-Activated Nitride Phosphor

The europium (II)-activated nitride phosphor is substantially expressed as
(MIV_{1-c}Eu_{c})MVSiN₃. General Formula (B)
In General Formula (B), MIV represents an alkali earth metal, and represents at least one element selected from among Mg, Ca, Sr, and Ba.

In General Formula (B), MV represents a trivalent metal element, and represents at least one element selected from among Al, Ga, In, Sc, Y, La, Gd, and Lu.

In General Formula (B) above, the value of c satisfies relation of 0.001≦c≦0.05 and preferably satisfies relation of 0.005≦c≦0.02. If the value of c is smaller than 0.001, sufficient brightness is not obtained. On the other hand, if the value of c exceeds 0.05, brightness significantly lowers due to concentration quenching or the like.

Specific examples of (B) europium (II)-activated nitride phosphor include (Ca_{0.98}Eu_{0.02})AlSiN₃, (Ca_{0.94}Mg_{0.05}Eu_{0.01})(Al_{0.99}In_{0.01}SiN₃, (Ca_{0.94}Mg_{0.05}Eu_{0.01})(Al_{0.99}Ga_{0.01})SiN₃, (Ca_{0.97}Mg_{0.01}Eu_{0.02})(Al_{0.99}Ga_{0.01})SiN₃, (Ca_{0.97}Sr_{0.01}Eu_{0.02})(Al_{0.98}In_{0.02})SiN₃, (Ca_{0.995}Eu_{0.005})AlSiN₃, (Ca_{0.989}Sr_{0.10}Eu_{0.001})(Al_{0.98}Ga_{0.02})SiN₃, (Ca_{0.93}Mg_{0.02}Eu_{0.05})AlSiN₃, (Ca_{0.97}Sr_{0.01}Eu_{0.02})(Al_{0.98}Ga_{0.02})SiN₃, (Ca_{0.985}Eu_{0.015})(Al_{0.99}In_{0.01})SiN₃, (Ca_{0.98}Mg_{0.01}Eu_{0.01})(Al_{0.99}Ga_{0.01})SiN₃, (Ca_{0.98}Eu_{0.02})(Al_{0.99}Ga_{0.01})SiN₃, and the like, however, it is naturally not limited as such.

A particle size (average particle size, Blane method) of the red light-emitting phosphor in the wavelength conversion portion of the light-emitting device of the present invention is not particularly limited either. Nevertheless, the particle size is preferably in a range from 3 to 10 μm, and more preferably in a range from 4 to 7 μm. If the particle size of the red light-emitting phosphor is smaller than 3 μm, crystal growth is insufficient and brightness tends to be significantly low. On the other hand, if the particles having a particle size exceeding 10 μm are prepared, generation of abnormally grown coarse particles is likely, which is not practical.

In the light-emitting device of the present invention, when the green light-emitting phosphor composed of (A-2) cerium (III)-activated silicate is used as the green or yellow light-emitting phosphor, the cerium (III)-activated silicate phosphor, in which MII in General Formula (A-2) above is at least one element selected from Mg and Ca, is preferably used. By using the cerium (III)-activated silicate phosphor as the green light-emitting phosphor, emission of green at further higher efficiency can be achieved.

In addition, in the light-emitting device of the present invention, the europium (II)-activated nitride phosphor, in which MV in General Formula (B) above is at least one element selected from Al, Ga and In, is preferably used as the red light-emitting phosphor. By using the europium (II)-activated nitride phosphor as the red light-emitting phosphor, emission of red at further higher efficiency can be achieved.

A plurality of phosphors used in the wavelength conversion portion in the light-emitting device of the present invention are preferably layered from an incident side toward an emission side of the primary light of the wavelength conversion portion, sequentially from a phosphor having a longer wavelength of the secondary light. As a result of layering in this manner, the light-emitting device, in which visible light emitted from a phosphor layer can effectively be extracted to the outside with little absorption in a phosphor layer provided thereon, can be provided. Specifically, the phosphors are suitably layered from the incident side toward the emission side of the primary light of the wavelength conversion portion, in an order of the red light-emitting phosphor and the green or yellow light-emitting phosphor (and the blue light-emitting phosphor).

A medium for the wavelength conversion portion in the light-emitting device of the present invention is not particularly limited, so long as the wavelength conversion portion is capable of containing the green or yellow light-emitting phosphor and the red light-emitting phosphor described above and absorbing a part of the primary light emitted from the light-emitting element and emitting the secondary light having a wavelength equal to or longer than wavelength of the primary light. Examples of the medium (transparent resin) include an epoxy resin, a silicone resin, a urea resin, and the like.

Naturally, the wavelength conversion portion may contain an appropriate additive such as SiO₂, TiO₂, ZrO₂, Al₂O₃, Y₂O₃, and the like, in addition to the phosphor and the medium described above, so long as such an additive does not impair an effect of the present invention.

As the light-emitting element used in the light-emitting device of the present invention, a gallium nitride (GaN)-based semiconductor may preferably be employed, from a viewpoint of efficiency.

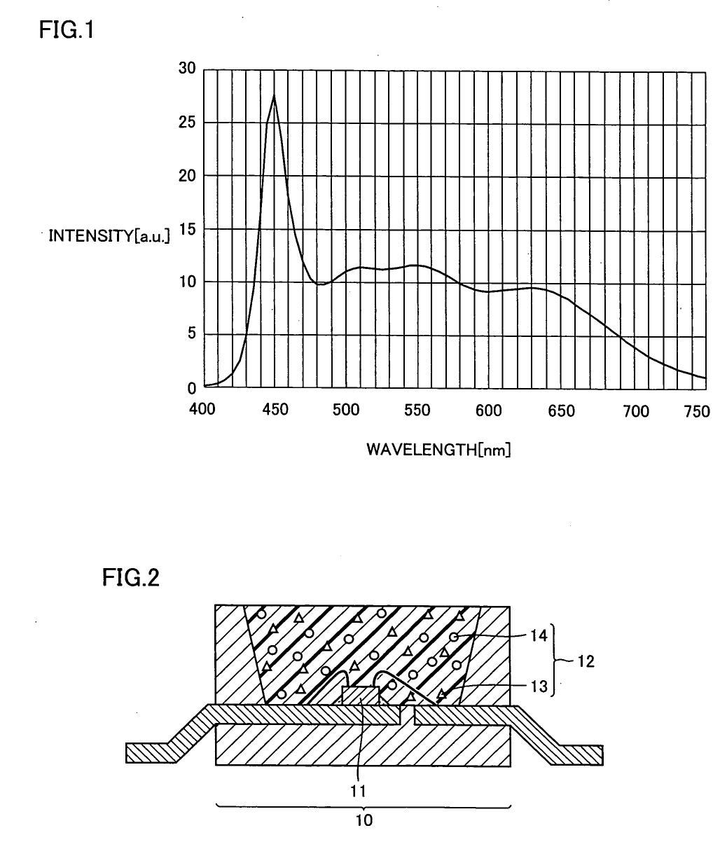

FIG. 1 shows emission spectrum distribution of a light-emitting device (Example 1 described later) representing a preferred example of the present invention. In FIG. 1, the ordinate represents luminous intensity (a.u.) and the abscissa represents a wavelength (nm). As shown in FIG. 1, in the light-emitting device including the wavelength conversion portion containing the green light-emitting phosphor and the red light-emitting phosphor described above, continuous spectrum distribution is observed over the entire visible region from 400 nm to 750 nm. Preferably, the light-emitting element used in the light-emitting device of the present invention emits the primary light having a peak wavelength in a range from 430 nm to 480 nm (more preferably in a range from 460 nm to 480 nm), from a viewpoint of efficient emission from the light-emitting device of the present invention.

If the peak wavelength of the primary light emitted by the light-emitting device is shorter than 430 nm, the color rendering property is deteriorated, which may result in failure in accomplishment of the object of the present invention. On the other hand, if the peak wavelength exceeds 480 nm, brightness of white color is lowered, which tends to be impractical.

The blue light-emitting phosphor used in the wavelength conversion portion in the light-emitting device of the present invention is implemented by at least one selected from among (C-1) europium (II)-activated halophosphate phosphor, (C-2) europium (II)-activated aluminate phosphor, and (C-3) europium (II)- and manganese-activated aluminate phosphor below.

(C-1) Europium (II)-Activated Halophosphate Phosphor

The europium (II)-activated halophosphate phosphor is substantially expressed as
(MVI,Eu)₁₀(PO₄)₆.Cl₂. General Formula (C-1)
In General Formula (C-1), MVI represents an alkali earth metal, and represents at least one element selected from among Mg, Ca, Sr, and Ba.

Specific examples of (C-1) europium (II)-activated halophosphate phosphor include (Sr_{0.74}Ba_{0.20}Ca_{0.05}Eu_{0.01})₁₀(PO₄)₆.Cl₂, (Sr_{0.685}Ba_{0.250}Ca_{0.050}Eu_{0.015})₁₀(PO₄)₆.Cl₂, (Sr_{0.695}Ba_{0.275}Ca_{0E.010}Eu_{0.020}) ₁₀(PO₄)₆.Cl₂, (Sr_{0.70}Ba_{0.28}Ca_{0.01}Eu_{0.01})₁₀(PO₄)₁₀₆.Cl₂, and the like, however, it is naturally not limited as such.

(C-2) Europium (II)-Activated Aluminate Phosphor

The europium (II)-activated aluminate phosphor is substantially expressed as
d(MVII,Eu)O.eAl₂O₃.
In General Formula (C-2), MVII represents a divalent metal element, and represents at least one element selected from among Mg, Ca, Sr, Ba, and Zn.

A ratio (d/e) between the divalent metal element and Al preferably satisfies relation of 0.1≦d/e≦1.0 Otherwise, properties as the satisfactory blue light-emitting phosphor cannot be obtained.

Specific examples of (C-2) europium (II)-activated aluminate phosphor include (Ba_{0.25}Sr_{0.60}Eu_{0.15})MgAl₁₀O₁₇, (Ba_{0.50}Sr_{0.30}Eu_{0.20})MgAl₁₀O₁₇, (Ba_{0.60}Sr_{0.20}Eu_{0.20})MgAl₁₀O₁₇, (Ba_{0.70}Sr_{0.15}Eu₁₅)MgAl₁₀O₁₇, (Ba_{0.30}Sr_{0.50}Eu_{0.20})MgAl₁₀O₁₇, (Ba_{0.50}Sr_{0.35}Eu_{0.15})MgAl₁₀O₁₇, and the like, however, it is naturally not limited as such.

(C-3) Europium (II)- and Manganese-Activated Aluminate Phosphor

The (C-3) europium (II)- and manganese-activated aluminate phosphor is substantially expressed as
f(MVII,Euₕ,Mnᵢ)O.gAl₂O₃. General Formula (C-3)
In General Formula (C-3), MVII represents a divalent metal element, and represents at least one element selected from among Mg, Ca, Sr, Ba, and Zn, as described above.

A ratio (f/g) between the divalent metal element and Al preferably satisfies relation of 0.1≦f/g≦1.0. Otherwise, properties as the satisfactory blue light-emitting phosphor cannot be obtained. In addition, a ratio (i/h) between europium and manganese preferably satisfies relation of 0.001≦i/h≦0.2. If the ratio is smaller than 0.001, contribution of emission of manganese is not observed. On the other hand, if the ratio exceeds 0.2, brightness of white color is lowered, which is not practical.

Specific examples of (C-3) europium (II)- and manganese-activated aluminate phosphor include (Ba_{0.40}Sr_{0.50}Eu_{0.10})(Mg_{0.99}Mn_{0.01})Al₁₀O₁₇, (Ba_{0.50}Sr_{0.30}Eu_{0.20})(Mg_{0.999}Mn_{0.001})Al₁₀O₁₇, (Ba_{0.45}Sr_{0.40}Eu_{0.15}) (Mg_{0.9985}Mn_{0.0015})Al₁₀O₁₇, (Ba_{0.65}Sr_{0.20}Eu_{0.15})(Mg_{0.97}Mn_{0.03})Al₁₀O₁₇, (Ba_{0.40}Sr_{0.40}Eu_{0.20})(Mg_{0.99}Mn_{0.01})Al₁₀O₁₇, and the like, however, it is naturally not limited as such.

A particle size of the blue light-emitting phosphor in the wavelength conversion portion of the light-emitting device of the present invention is not particularly limited either, however, in the case of (C-1) europium (II)-activated halophosphate phosphor, the particle size is preferably in a range from 3.0 to 9.0 μm, and more preferably in a range from 4.5 to 6.5 cm. If the particle size of (C-1) europium (II)-activated halophosphate phosphor is smaller than 3.0 μm, crystal growth is insufficient and brightness tends to be significantly low. On the other hand, if the particles having a particle size exceeding 9.0 μm are prepared, generation of abnormally grown coarse particles is likely, which tends to be impractical. In the case of (C-2) europium (II)-activated aluminate phosphor or (C-3) europium (II)- and manganese-activated aluminate phosphor, the particle size is preferably in a range from 2.0 to 7.0 μm, and more preferably in a range from 3.0 to 5.0 μm. If the particle size of (C-2) europium (II)-activated aluminate phosphor or (C-3) europium (II)- and manganese-activated aluminate phosphor is smaller than 2.0 μm, crystal growth is insufficient and brightness tends to be significantly low. On the other hand, if the particles having a particle size exceeding 7.04 μm are prepared, generation of abnormally grown coarse particles is likely, which tends to be impractical.

In the light-emitting device including the wavelength conversion portion that further contains the blue light-emitting phosphor in addition to the green or yellow light-emitting phosphor and the red light-emitting phosphor described above, phosphors suitable as the green or yellow light-emitting phosphor and the red light-emitting phosphor are as described above. In addition, in such a light-emitting device, a plurality of phosphors used in the wavelength conversion portion are preferably layered from a light incident side toward a light emission side of the wavelength conversion portion, sequentially from a phosphor having a longer wavelength of the secondary light. Moreover, a medium as described above can suitably be used as the medium for forming the wavelength conversion portion.

As the light-emitting element used in the light-emitting device including the wavelength conversion portion that further contains the blue light-emitting phosphor in addition to the green or yellow light-emitting phosphor and the red light-emitting phosphor described above, a gallium nitride (GaN)-based semiconductor may preferably be employed, from a viewpoint of efficiency.

In addition, the light-emitting element used in the light-emitting device including the wavelength conversion portion that further contains the blue light-emitting phosphor in addition to the green or yellow light-emitting phosphor and the red light-emitting phosphor preferably emits the primary light having a peak wavelength in a range from 380 nm to 430 nm, and more preferably in a range from 395 nm to 410 nm, from a viewpoint of efficient emission of the blue light-emitting phosphor. If the peak wavelength of the primary light emitted by the light-emitting element is shorter than 380 nm, deterioration of a resin or the like is no longer negligible, which may be impractical. On the other hand, if the peak wavelength exceeds 430 nm, luminous intensity of the blue light-emitting phosphor significantly lowers, which may be impractical.

In the light-emitting device including the wavelength conversion portion that further contains the blue light-emitting phosphor in addition to the green or yellow light-emitting phosphor and the red light-emitting phosphor, the blue light-emitting phosphor is preferably implemented by the europium (II)-activated halophosphate phosphor expressed in General Formula (C-1) above, and the blue light-emitting phosphor preferably has the emission peak wavelength in a range from 460 nm to 480 nm. If the emission peak wavelength of the blue light-emitting phosphor is shorter than 460 nm, the value of special color rendering index R12 is lowered and color rendering AAA standard cannot be satisfied. On the other hand, if the emission peak wavelength of the blue light-emitting phosphor exceeds 480 nm, output of white light significantly lowers, which tends to be impractical from a viewpoint of satisfying color rendering AAA.

The light-emitting device of the present invention preferably emits white light.

The light-emitting device according to the present invention preferably (1) attains correlated color temperature in a range from 5700K to 7100K, general color rendering index of at least 90, and special color rendering indices R9 to R15 of at least 90, or (2) attains correlated color temperature in a range from 4600K to 5400K, general color rendering index of at least 90, and special color rendering indices R9 to R15 of at least 90, when the green or yellow light-emitting phosphor described above is used as the green light-emitting phosphor (that is, when (A-1) europium (II)-activated silicate phosphor having a specific composition is used alone, when (A-2) cerium (III)-activates silicate phosphor is used alone, and when the former two phosphors are used in combination).

In addition, the light-emitting device of the present invention preferably emits white light at a correlated color temperature not higher than 4000K when the green or yellow light-emitting phosphor described above is used as the yellow light-emitting phosphor (that is, when (A-1) europium (II)-activated silicate phosphor having a specific composition is used alone).

Here, the correlated color temperature is defined under JIS-Z8725, while the general color rendering index and the special color rendering index are defined under JIS-Z8726.

A phosphor fabricated with a conventionally known, appropriate method or naturally a commercially available phosphor may be used as the green or yellow light-emitting phosphor, the red light-emitting phosphor and the blue light-emitting phosphor in the light-emitting device of the present invention. In addition, the wavelength conversion portion in the light-emitting device of the present invention may be fabricated by diff-using the green or yellow light-emitting phosphor and the red light-emitting phosphor (and the blue light-emitting phosphor in some cases) described above in an appropriate resin, followed by forming under an appropriate condition, and a fabrication method thereof is not particularly limited.

### EXAMPLE

In the following, the present invention will be described in further detail with reference to examples and comparative examples, however, the present invention is not limited thereto.

### Example 1

FIG. 2 is a schematic longitudinal cross-sectional view of a light-emitting device of Example 1 of the present invention. A light-emitting device 10 includes a light-emitting element 11 emitting primary light, and a wavelength conversion portion 12 absorbing at least a part of the primary light and emitting secondary light having a wavelength equal to or longer than wavelength of the primary light. Wavelength conversion portion 12 contains a red light-emitting phosphor 13 and a green light-emitting phosphor 14 diffused in a resin.

In Example 1, a gallium nitride (GaN)-based semiconductor having a peak wavelength at 450 nm was used as the light-emitting element. Ca₃(Sc_{0.85}Ce_{0.15})₂(SiO₄)₃ (particle size: 8.9 μm) and (Ca_{0.98}Eu_{0.02})AlSiN₃ (particle size: 3.8 μm) were used as the green light-emitting phosphor and the red light-emitting phosphor respectively, to fabricate the wavelength conversion portion. Mixture of the green light-emitting phosphor and the red light-emitting phosphor at a weight ratio of 1:0.3 was diffused in an epoxy resin, followed by forming, thereby fabricating the wavelength conversion portion. The light-emitting device in Example 1 structured as shown in FIG. 2 was thus fabricated.

### Comparative Example 1

The light-emitting device was fabricated as in Example 1, except for diffusing solely a yellow light-emitting phosphor expressed as (Y_{0.50}Gd_{0.35}Ce_{0.15})₃Al₅O₁₂ in the resin to form the wavelength conversion portion.

### Example 2

A gallium nitride (GaN)-based semiconductor having a peak wavelength at 435 nm was used as the light-emitting element. Fifty weight % 2(Ba_{0.60}Sr_{0.38}Eu_{0.02})O.SiO₂ having a particle size of 9.3 μm and 50 weight % 2(Sr_{0.80}Ba_{0.18}Eu_{0.02})O.SiO₂ having a particle size of 10.5 μm, and (Ca_{0.94}Mg_{0.05}Eu_{0.01})(Al_{0.99}In_{0.01})SiN₃ having a particle size of 3.61 μm were used as the green light-emitting phosphor and the red light-emitting phosphor respectively, to fabricate the wavelength conversion portion. Mixture of combination of the green light-emitting phosphors and the red light-emitting phosphor at a weight ratio of 1:0.31 was diffused in a silicone resin, followed by forming, thereby fabricating the wavelength conversion portion. The light-emitting device in Example 2 structured as shown in FIG. 2 was thus fabricated.

### Comparative Example 2

The light-emitting device was fabricated as in Example 1, except for employing a gallium nitride (GaN)-based semiconductor having a peak wavelength at 435 nm as the light-emitting element, and diffusing solely a yellow light-emitting phosphor expressed as 2(Sr_{0.93}Ba_{0.05}Eu_{0.02})O.SiO₂ in the resin to form the wavelength conversion portion.

### Example 3

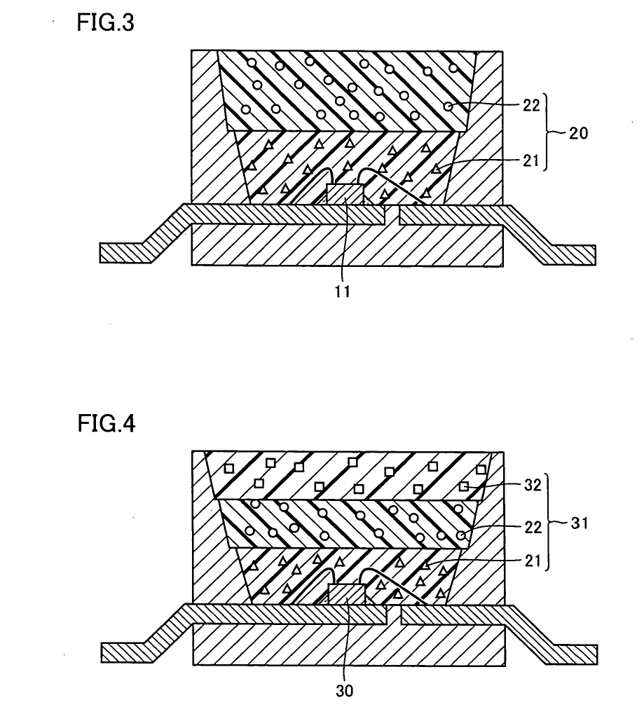

FIG. 3 is a schematic longitudinal cross-sectional view of the light-emitting device of Example 3 of the present invention. The light-emitting device includes light-emitting element 11 emitting primary light and a wavelength conversion portion 20 absorbing at least a part of the primary light and emitting secondary light having a wavelength equal to or longer than wavelength of the primary light. Wavelength conversion portion 20 includes a resin layer containing diffused red light-emitting phosphor (red light-emitting phosphor layer) 21 and a resin layer containing diffused green light-emitting phosphor (green light-emitting phosphor layer) 22. Red light-emitting phosphor layer 21 is arranged proximate to light-emitting element 11, and green light-emitting phosphor layer 22 is layered thereon.

In Example 3, a gallium nitride (GaN)-based semiconductor having a peak wavelength at 435 nm was used as the light-emitting element. (Ca_{0.8}Mg_{0.2})₃(Sc_{0.75}Ga_{0.15}Ce_{0.10})₂(SiO₄)₃ having a particle size of 8.91 μm and (Ca_{0.94}Mg_{0.05}Eu_{0.01})(Al_{0.99}Ga_{0.01})SiN₃ having a particle size of 3.8 μm were used as the green light-emitting phosphor and the red light-emitting phosphor respectively, to fabricate the wavelength conversion portion. Initially, the red light-emitting phosphor was diffused in an epoxy resin, followed by forming, thereby forming a first resin layer (red light-emitting phosphor layer). The green light-emitting phosphor was diffused in an epoxy resin, followed by forming, thereby forming a second resin layer (green light-emitting phosphor layer) on the first resin layer. The wavelength conversion portion having a two-layered structure was thus fabricated. The light-emitting device in Example 3 structured as shown in FIG. 3 was thus fabricated.

### Comparative Example 3

The light-emitting device was fabricated as in Example 1, except for employing a gallium nitride (GaN)-based semiconductor having a peak wavelength at 425 nm as the light-emitting element, and diff-using solely a yellow light-emitting phosphor expressed as 2(Sr_{0.900}Ba_{0.085}Eu_{0.015})O.SiO₂ in the resin to form the wavelength conversion portion.

Properties of the light-emitting devices in Examples 1 to 3 and Comparative Examples 1 to 3 were evaluated. Table 1 shows the result.

TABLE 1

| | | | | Special Color |
|---|---|---|---|---|
| | Brightness | | General Color | Rendering Index |
| | (Relative Value (%)) | Tc-duv | Rendering Index (Ra) | (R9) |
| Example 1 | 99.0 | 6900 K + 0.001 | 95.0 | 92.0 |
| Comparative | 100.0 | 6900 K + 0.001 | 68.0 | −40.5 |
| Example 1 | | | | |
| Example 2 | 98.8 | 7700 K ± 0.000 | 93.5 | 94.0 |
| Comparative | 100.0 | 7700 K ± 0.000 | 69.2 | −40.8 |
| Example 2 | | | | |
| Example 3 | 122.1 | 8500 K − 0.002 | 94.1 | 92.1 |
| Comparative | 100.0 | 8500 K − 0.002 | 69.9 | −38.6 |
| Example 3 | | | | |

Here, brightness was found by illumination under the condition of a forward current (IF) of 20 mA and by conversion of white light from the light-emitting device to a photocurrent. Values of Tc-duv, general color rendering index (Ra) and special color rendering index (R9) were found by illumination under the condition of a forward current (IF) of 20 mA and by measurement of white light emitted from the light-emitting device using MCPD-2000 manufactured by Otsuka Electronics Co., Ltd.

### Examples 4 and 5, Comparative Examples 4 and 5

The light-emitting device was fabricated using the method the same as in Example 1, and Table 2 shows the result of evaluation of various properties.

TABLE 2

| | Light- | | Brightness | | General Color | Special Color |
|---|---|---|---|---|---|---|
| | Emitting | | (Relative | | Rendering | Rendering Index |
| | Element | Phosphor | Value) | Tc-duv | Index(Ra) | (R9) |
| Example 4 | 460 nm | Red: (Ca_{0.98}Eu_{0.02})AlSiN₃ | 98.1% | 4800 K + 0.001 | 93.9 | 93.0 |
| | | Green: (Ca_{0.9}Mg_{0.1})₃(Sc_{0.90}Ce_{0.10})₂(SiO₄)₃ | | | | |
| Comparative | 460 nm | (Y_{0.40}Gd_{0.45}Ce_{0.15})₃Al₅O₁₂ | 100.0% | 4800 K + 0.001 | 68.1 | −42.0 |
| Example 4 | | | | | | |
| Example 5 | 430 nm | Red: (Ca_{0.98}Eu_{0.02})AlSiN₃ | 98.7% | 3000 K + 0.002 | 92.0 | 70.0 |
| | | Green: 2(Ba_{0.55}Sr_{0.43}Eu_{0.02})O.SiO₂(55%) | | | | |
| | | 2(Ba_{0.83}Sr_{0.15}Eu_{0.02})O.SiO₂(45%) | | | | |
| Comparative | 420 nm | 2(Sr_{0.92}Ba_{0.06}Eu_{0.02})O.SiO₂ | 100.0% | 3000 K + 0.002 | 67.0 | −50.3 |
| Example 5 | | | | | | |

As can be seen from Table 2, the light-emitting device according to the present invention achieves significantly improved color rendering property, as compared with a conventional product.

### Example 6, Comparative Example 6

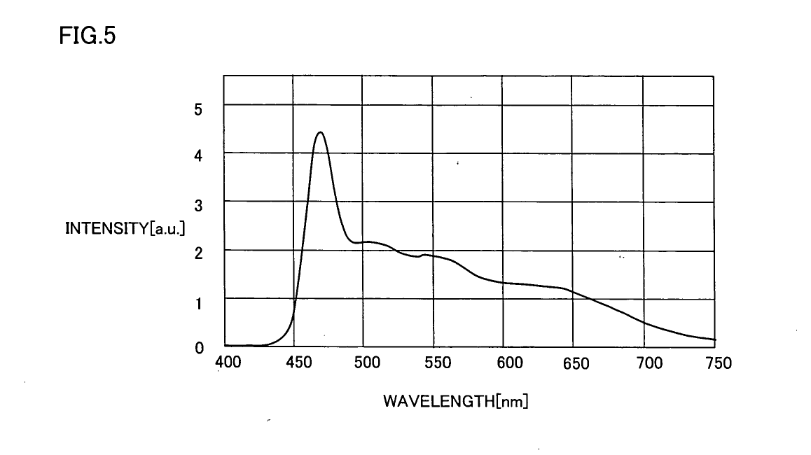

FIG. 4 is a schematic longitudinal cross-sectional view of the light-emitting device of Example 6 of the present invention. The light-emitting device includes a light-emitting element 30 emitting primary light and a wavelength conversion portion 31 absorbing at least a part of the primary light and emitting secondary light having a wavelength equal to or longer than wavelength of the primary light. Wavelength conversion portion 31 includes resin layer containing diffused red light-emitting phosphor (red light-emitting phosphor layer) 21, resin layer containing diffused green light-emitting phosphor (green light-emitting phosphor layer) 22, and a resin layer containing diffused blue light-emitting phosphor (blue light-emitting phosphor layer) 32. Red light-emitting phosphor layer 21 is arranged proximate to light-emitting element 30, and green light-emitting phosphor layer 22 and blue light-emitting phosphor layer 32 are successively layered thereon.

In Example 6, a gallium nitride (GaN)-based semiconductor having a peak wavelength at 380 nm was used as the light-emitting element. (Sr_{0.74}Ba_{0.20}Ca_{0.05}Eu_{0.01})₁₀(PO₄)₆.Cl₂, 55 weight % 2(Ba_{0.55}Sr_{0.43}Eu_{0.02})O.SiO₂ and 45 weight % 2(Sr_{0.83}Ba_{0.15}Eu_{0.02})O.SiO₂, and (Ca_{0.98}Eu_{0.02})AlSiN₃ were used as the blue light-emitting phosphor, the green light-emitting phosphor and the red light-emitting phosphor respectively, to fabricate the wavelength conversion portion. In fabricating the wavelength conversion portion, initially, the red light-emitting phosphor layer was formed, and the green light-emitting phosphor layer was formed thereon. In addition, the blue light-emitting phosphor layer was formed on the green light-emitting phosphor layer. Properties of the light-emitting device structured as shown in FIG. 4 and incorporating this wavelength conversion portion were evaluated. Table 3 shows the result.

Meanwhile, in Comparative Example 6, a gallium nitride (GaN)-based semiconductor having a peak wavelength at 430 nm was used as the light-emitting element, and the yellow light-emitting phosphor expressed as 2(Sr_{0.93}Ba_{0.05}Eu_{0.02})O.SiO₂ was used in the wavelength conversion portion.

TABLE 3

| | Brightness | | | |
|---|---|---|---|---|
| | (Relative Value | | General Color | Special Color |
| | (%)) | Tc-duv | Rendering Index (Ra) | Rendering Index (R9) |
| Example 6 | 123.0 | 6800 K − 0.001 | 93.5 | 92.9 |
| Comparative | 100.0 | 6800 K − 0.001 | 68.3 | −42.0 |
| Example 6 | | | | |

As can be seen from Table 3, the light-emitting device according to the present invention achieves significantly improved brightness and color rendering property, as compared with a conventional product.

### Examples 7-9, Comparative Examples 7-9

The light-emitting device was fabricated using the method the same as in Example 1, and Table 4 shows the result of evaluation of various properties.

TABLE 4

| | | | | | General | Special |
|---|---|---|---|---|---|---|
| | Light- | | Brightness | | Color | Color |
| | Emitting | | (Relative | | Rendering | Rendering |
| | Element | Phosphor | Value) | Tc-duv | Index(Ra) | Index(R9) |
| Example 7 | 420 nm | Red: (Ca_{0.98}Eu_{0.02})AlSiN₃ | 98.3% | 8300 K + 0.002 | 94.5 | 92.5 |
| | | Green: (Ca_{0.9}Mg_{0.1})₃(Sc_{0.85}Ce_{0.15})₂(SiO₄)₃ | | | | |
| | | Blue: (Ba_{0.25}Sr_{0.60}Eu_{0.15})MgAl₁₀O₁₇ | | | | |
| Comparative | 440 nm | 2(Sr_{0.900}Ba_{0.065}Ca_{0.020}Eu_{0.015})O.SiO₂ | 100.0% | 8300 K + 0.002 | 68.8 | −39.9 |
| Example 7 | | | | | | |
| Example 8 | 415 nm | Red: (Ca_{0.97}Mg_{0.01}Eu_{0.02})(Al_{0.99}Ga_{0.01})SiN₃ | 99.1% | 5000 K + 0.001 | 95.0 | 92.9 |
| | | Green: (Ca_{0.85}Mg_{0.15})₃(Sc_{0.80}Y_{0.05}Ce_{0.15})₂(SiO₄)₃ | | | | |
| | | Blue: (Ba_{0.40}Sr_{0.50}Eu_{0.10})(Mg_{0.99}Mn_{0.01})Al₁₀O₁₇ | | | | |
| Comparative | 460 nm | 2(Sr_{0.92}Ba_{0.06}Eu_{0.02})O.SiO₂ | 100.0% | 5000 K + 0.001 | 69.0 | −43.2 |
| Example 8 | | | | | | |
| Example 9 | 405 nm | Red: (Ca_{0.97}Sr_{0.01}Eu_{0.02})(Al_{0.98}In_{0.02})SiN₃ | 98.7% | 4000 K − 0.001 | 94.0 | 92.2 |
| | | Green: 2(Ba_{0.65}Sr_{0.33}Eu_{0.02})O.SiO₂(45%) | | | | |
| | | 2(Sr_{0.78}Ba_{0.20}Eu_{0.02})O.SiO₂(55%) | | | | |
| | | Blue: (Ba_{0.50}Sr_{0.30}Eu_{0.02})MgAl₁₀O₁₇ | | | | |
| Comparative | 450 nm | 2(Sr_{0.93}Ba_{0.05}Eu_{0.02})O.SiO₂ | 100.0% | 4000 K − 0.001 | 68.1 | −44.0 |
| Example 9 | | | | | | |

As can be seen from Table 4, the light-emitting device according to the present invention achieves significantly improved color rendering property, as compared with a conventional product.

### Example 10

A gallium nitride (GaN)-based semiconductor having a peak wavelength at 470 nm was used as the light-emitting element. Ca₃(Sc_{0.90}Ce_{0.10})₂(SiO₄)₃ and (Ca_{0.98}Eu_{0.02})AlSiN₃ (particle size: 3.8 μm) were used as the green light-emitting phosphor and the red light-emitting phosphor respectively, to fabricate the wavelength conversion portion. Mixture of the green light-emitting phosphor and the red light-emitting phosphor at a weight ratio of 1:0.2 was diffused in an epoxy resin, followed by forming, thereby fabricating the wavelength conversion portion. The light-emitting device in Example 10 structured as shown in FIG. 2 was thus fabricated.

### Comparative Example 10

The light-emitting device was fabricated as in Example 10, except for diffusing solely a yellow light-emitting phosphor expressed as (Y_{0.45}Gd_{0.40}Ce_{0.15})₃Al₅O₁₂ in the resin to form the wavelength conversion portion.

With regard to Example 10 and Comparative Example 10 above, not only brightness, Tc-duv, general color rendering index (Ra), and special color rendering index (R9) described above but also special color rendering indices (R10), (R11), (R12), (R13), (R14), and (R15) were evaluated. Tables 5 and 6 show the result.

TABLE 5

| | | | | Special Color |
|---|---|---|---|---|
| | Brightness | | General Color | Rendering Index |
| | (Relative Value (%)) | Tc-duv | Rendering Index (Ra) | (R9) |
| Example 10 | 98.5 | 6700 K + 0.002 | 95.2 | 92.6 |
| Comparative | 100.0 | 6700 K + 0.002 | 68.3 | −39.7 |
| Example 10 | | | | |

TABLE 6

| | R10 | R11 | R12 | R13 | R14 | R15 |
|---|---|---|---|---|---|---|
| Example 10 | 92.2 | 94.8 | 91.8 | 98.2 | 98.2 | 94.3 |
| Comparative | 38.0 | 63.3 | 35.0 | 67.3 | 87.1 | 60.8 |
| Example 10 | | | | | | |

As can be seen from Tables 5 and 6, the light-emitting device according to Example 10 achieves significantly improved color rendering property, as compared with Comparative Example 10 representing a conventional product, and it satisfies the color rendering AAA standard. FIG. 5 shows emission spectrum distribution of Example 10. As can be seen from the emission spectrum distribution in FIG. 5, an emission component is not observed in a region of a wavelength shorter than 400 nm. Therefore, it can be seen that the light-emitting device in Example 10 is optimal as the illumination source in an art museum and a museum.

### Example 11

A gallium nitride (GaN)-based semiconductor having a peak wavelength at 480 nm was used as the light-emitting element. Fifty weight % 2(Ba_{0.60}Sr_{0.38}Eu_{0.02})O.SiO₂ having a particle size of 9.3 μm and 50 weight % 2(Sr_{0.80}Ba_{0.18}Eu_{0.02})O.SiO₂ having a particle size of 10.51 μm, and (Ca_{0.97}Mg_{0.01}Eu_{0.02})(Al_{0.99}In_{0.01})SiN₃ were used as the green light-emitting phosphor and the red light-emitting phosphor respectively, to fabricate the wavelength conversion portion. Mixture of combination of the green light-emitting phosphors and the red light-emitting phosphor was diffused in a silicone resin, followed by forming, thereby fabricating the wavelength conversion portion. The light-emitting device of Example 11 structured as shown in FIG. 2 was thus fabricated.

### Example 12

The light-emitting device according to Example 12 structured as shown in FIG. 2 was fabricated as in Example 11, except for employing a gallium nitride (GaN)-based semiconductor having a peak wavelength at 445 nm as the light-emitting element.

With regard to Examples 11 and 12 as well, not only Tc-duv, general color rendering index (Ra) and special color rendering index (R9) but also special color rendering indices (R10), (R11), (R12), (R13), (R14), and (R15) were evaluated, as in Example 10 and Comparative Example 10 described above. Tables 7 and 8 show the result.

TABLE 7

| | | | | Special Color |
|---|---|---|---|---|
| | Brightness | | General Color | Rendering Index |
| | (Relative Value (%)) | Tc-duv | Rendering Index (Ra) | (R9) |
| Example 11 | 99.0 | 6500 K − 0.001 | 93.5 | 95.0 |
| Example 12 | 100.0 | 6500 K − 0.001 | 68.3 | 93.0 |

TABLE 8

| | R10 | R11 | R12 | R13 | R14 | R15 |
|---|---|---|---|---|---|---|
| Example 11 | 91.8 | 94.6 | 91.3 | 98.5 | 98.1 | 94.6 |
| Example 12 | 91.2 | 93.1 | 68.9 | 98.5 | 97.6 | 93.8 |

As shown in Tables 7 and 8, it can be seen that the light-emitting device according to Example 11 satisfies the color rendering AAA standard. In the light-emitting device according to Example 11, in addition to selection of the peak wavelength of the light-emitting element and combination with the red light-emitting phosphor, two europium-activated phosphors different in a composition ratio of Ba and Sr were selected and used as the green light-emitting phosphor, so that the peak wavelength is displaced and the broader green spectrum is achieved, thus attaining enhanced color rendering property. Here, it can be seen that Example 12 employing the light-emitting element of which peak wavelength is 460 nm (blue emission component) cannot satisfy the color rendering AAA standard, because the value of R12 is lower.

### Example 13

A gallium nitride (GaN)-based semiconductor having a peak wavelength at 460 nm was used as the light-emitting element. (Ca_{0.8}Mg_{0.2})₃(Sc_{0.85}Ga_{0.05}Ce_{0.10})₂(SiO₄)₃ and (Ca_{0.98}Eu_{0.02})(Al_{0.99}Ga_{0.01})SiN₃ were used as the green light-emitting phosphor and the red light-emitting phosphor respectively, to fabricate the wavelength conversion portion. In fabricating the wavelength conversion portion, initially, the red light-emitting phosphor layer was formed, and the green light-emitting phosphor layer was formed thereon. Brightness, Tc-duv and general color rendering index (Ra) of the light-emitting device structured as shown in FIG. 3 and incorporating this wavelength conversion portion were evaluated. Table 9 shows the result.

### Example 14

The light-emitting device structured as shown in FIG. 2 was fabricated as in Example 13, except for mixing the green light-emitting phosphor and the red light-emitting phosphor to fabricate a one-layered wavelength conversion portion. Table 9 shows the result of evaluation performed in a manner the same as in Example 13.

TABLE 9

| | Brightness | | |
|---|---|---|---|
| | (Relative Value | | General Color |
| | (%)) | Tc-duv | Rendering Index (Ra) |
| Example 13 | 127.7 | 5200 K − 0.002 | 95.7 |
| Example 14 | 100.0 | 5200 K − 0.002 | 95.7 |

As can be seen from Table 9, it is seen that brightness of the light-emitting device of the present invention was significantly improved, by fabricating the wavelength conversion portion in such a manner that a plurality of phosphors are layered from an incident side toward an emission side of the primary light of the wavelength conversion portion, sequentially from a phosphor having a longer wavelength of the secondary light. Here, both Examples 13 and 14 satisfied the color rendering AAA standard, in terms of not only general color rendering index (Ra) but also special color rendering indices (R9 to R15) (data not shown).

### Example 15

A gallium nitride (GaN)-based semiconductor having a peak wavelength at 380 nm was used as the light-emitting element. (Ba_{0.60}Sr_{0.35}Ca_{0.03}Eu_{0.02})₁₀(PO₄)₆.Cl₂ having an emission peak wavelength at 470 nm, 55 weight % 2(Ba_{0.55}Sr_{0.43}Eu_{0.02})O.SiO₂ and 45 weight % 2(Sr_{0.83}Ba_{0.15}Eu_{0.02})O.SiO₂, and (Ca_{0.98}Eu_{0.02})AlSiN₃ were used as the blue light-emitting phosphor, the green light-emitting phosphor and the red light-emitting phosphor respectively, to fabricate the wavelength conversion portion. Mixture of the blue light-emitting phosphor, combination of the green light-emitting phosphors, and the red light-emitting phosphor was diffused in a silicone resin, followed by forming, thereby fabricating the wavelength conversion portion. Brightness, Tc-duv, general color rendering index (Ra), and special color rendering indices (R9 to R15) of the light-emitting device according to Example 15 incorporating this wavelength conversion portion were evaluated. Tables 10 and 11 show the result.

### Example 16

The light-emitting device was fabricated as in Example 15, except for employing (Sr_{0.99}Eu_{0.01})₁₀(PO₄)₆.Cl₂ having an emission peak wavelength at 445 nm a the blue light-emitting phosphor. Tables 10 and 11 show the result of evaluation performed in a manner the same as in Example 15.

TABLE 10

| | Brightness | | |
|---|---|---|---|
| | (Relative Value | | General Color |
| | (%)) | Tc-duv | Rendering Index (Ra) |
| Example 15 | 98.2 | 6300 K − 0.001 | 96.5 |
| Example 16 | 100.0 | 6300 K − 0.001 | 92.3 |

TABLE 11

| | R9 | R10 | R11 | R12 | R13 | R14 | R15 |
|---|---|---|---|---|---|---|---|
| Example 15 | 95.8 | 92.5 | 95.2 | 91.6 | 98.8 | 97.6 | 95.3 |
| Example 16 | 92.6 | 90.4 | 93.1 | 64.8 | 96.0 | 95.1 | 93.3 |

As can be seen from Tables 10 and 11, it is seen that the light-emitting device according to Example 15 satisfies the color rendering AAA standard. In contrast, Example 16 in which the emission peak wavelength of the blue light-emitting phosphor is shorter than 460 nm cannot satisfy the color rendering AAA standard, because the value of R12 is lower. Here, in Example 15, a part of light of a wavelength of 380 nm from the light-emitting element goes outside. Therefore, if such a light-emitting element is used as the illumination source in an art museum and a museum, a film absorbing light of a wavelength not longer than 400 nm should be provided.

### Example 17

A gallium nitride (GaN)-based semiconductor having a peak wavelength at 400 nm was used as the light-emitting element. (Ba_{0.560} Sr_{0.415}Ca_{0.010}Eu_{0.015})₁₀(PO₄)₆.Cl₂ having the emission peak wavelength of 465 nm, (Ca_{0.8}Mg_{0.2})₃(Sc_{0.99}Ce_{0.01})₂(SiO₄)₃, and (Ca_{0.985}Eu_{0.015})AlSiN₃ were used as the blue light-emitting phosphor, the green light-emitting phosphor, and the red light-emitting phosphor respectively, to fabricate the wavelength conversion portion. In fabricating the wavelength conversion portion, initially, the red light-emitting phosphor layer was formed, and the green light-emitting phosphor layer was formed thereon. In addition, the blue light-emitting phosphor layer was formed on the green light-emitting phosphor layer. Brightness, Tc-duv and general color rendering index (Ra) of the light-emitting device structured as shown in FIG. 4 and incorporating this wavelength conversion portion were evaluated. Table 12 shows the result.

### Example 18

The light-emitting device was fabricated as in Example 17, except for mixing the green light-emitting phosphor, the red light-emitting phosphor and the blue light-emitting phosphor to fabricate a one-layered wavelength conversion portion. Table 12 shows the result of evaluation performed in a manner the same as in Example 17.

TABLE 12

| | Brightness | | |
|---|---|---|---|
| | (Relative Value | | General Color |
| | (%)) | Tc-duv | Rendering Index (Ra) |
| Example 17 | 125.6 | 7000 K + 0.001 | 96.1 |
| Example 18 | 100.0 | 7000 K + 0.001 | 96.0 |

As can be seen from Table 12, it is seen that brightness of the light-emitting device of the present invention was significantly improved, by fabricating the wavelength conversion portion in such a manner that a plurality of phosphors are layered from an incident side toward an emission side of the primary light of the wavelength conversion portion, sequentially from a phosphor having a longer wavelength of the secondary light. Here, both Examples 17 and 18 satisfied the color rendering AAA standard, in terms of not only general color rendering-index (Ra) but also special color rendering indices (R9 to R15) (data not shown).

### Example 19, Comparative Example 11

A gallium nitride (GaN)-based semiconductor light-emitting element having a peak wavelength at 450 nm was used as the light-emitting element. Here, 2(Sr_{0.93}Ba_{0.05}Eu_{0.02})O.SiO₂ and (Ca_{0.98}Eu_{0.02})AlSiN₃ were used as the yellow light-emitting phosphor and the red light-emitting phosphor respectively, to fabricate the wavelength conversion portion. Mixture of the yellow light-emitting phosphor and the red light-emitting phosphor at a weight ratio of 1:0.2 was diffused in an epoxy resin, followed by forming, thereby fabricating the wavelength conversion portion. The light-emitting device in Example 19 structured as shown in FIG. 2 was thus fabricated.

On the other hand, in Comparative Example 11, the light-emitting device was fabricated as in Example 19, except for diffusing solely a yellow light-emitting phosphor expressed as (Y_{0.50}Gd_{0.35}Ce_{0.15})₃Al₅O₁₂ in the resin to form the wavelength conversion portion.

Table 13 shows the result of evaluation of brightness and Tc-duv of the light-emitting devices according to Example 19 and Comparative Example 11.

TABLE 13

| | Brightness | |
|---|---|---|
| | (Relative Value (%)) | Tc-duv |
| Example 19 | 88.3 | 3000 K + 0.001 |
| Comparative Example 11 | 100.0 | 3000 K + 0.040 |

As can clearly be seen from Table 13, in the light-emitting device according to Example 19, non-yellowish, clear white light having less blackbody locus deviation was obtained, as compared with Comparative Example 11 corresponding to a conventional product. Namely, deviation (duv) in Example 19 is considerably smaller than that in Comparative Example 11.

Here, as to Tc-duv described above, Tc represents a correlated color temperature of a color of emitted light from the light-emitting device, while duv represents deviation of emission chromaticity point from blackbody radiation locus (length of the normal from the chromaticity point of the color of emitted light to the blackbody radiation locus on a U*V*W* chromaticity diagram (CIE1964 uniform color space)). It is defined that, if duv is not larger than 0.01, emission is felt as colorless white, as in the case of a normal tungsten filament lamp and the like.

In Table 13, brightness of the light-emitting device of Example 19 is lower than that of Comparative Example 11. Here, if a composition range of the phosphor in the present invention is adjusted in order to attain the value of Tc-duv as great as in Comparative Example 11, brightness substantially equal to or greater than Comparative Example 11 can be obtained. Meanwhile, in Comparative Example 11, however the composition range of the phosphor may be adjusted, Tc-duv comparable to Example 19 cannot be obtained.

### Examples 20 and 21

A gallium nitride (GaN)-based semiconductor light-emitting element having a peak wavelength at 450 nm was used as the light-emitting element. Here, 2(Sr_{0.900}Ba_{0.075}Ca_{0.010}Eu_{0.015})O.SiO₂ and (Ca_{0.97}Sr_{0.01}Eu_{0.02})(Al_{0.98}Ga_{0.02}SiN₃ were used as the yellow light-emitting phosphor and the red light-emitting phosphor respectively, to fabricate the wavelength conversion portion. Initially, the red light-emitting phosphor was diffused in an epoxy resin, followed by forming, thereby forming a red light-emitting phosphor layer. The yellow light-emitting phosphor was diffused in an epoxy resin, followed by forming, thereby forming a yellow light-emitting phosphor layer on the red light-emitting phosphor layer. The wavelength conversion portion having a two-layered structure was thus fabricated. The light-emitting device of Example 20 structured as shown in FIG. 3 was thus fabricated.

The light-emitting device according to Example 21 structured as shown in FIG. 2 was fabricated as in Example 20, except for mixing the yellow light-emitting phosphor and the red light-emitting phosphor to fabricate a one-layered wavelength conversion portion.

Table 14 shows the result of evaluation of brightness and Tc-duv of Examples 20 and 21.

TABLE 14

| | Brightness | |
|---|---|---|
| | (Relative Value (%)) | Tc-duv |
| Example 20 | 116.2 | 2800 K + 0.001 |
| Example 21 | 100.0 | 2800 K + 0.001 |

As can clearly be seen from Table 14, in the light-emitting device according to Example 20 as well, non-yellowish, clear white light was obtained. As can clearly be seen from comparison with Example 21, brightness of the light-emitting device was significantly improved, by layering resin layers, sequentially from a layer containing a phosphor having a longer wavelength of the secondary light, from the side of the light-emitting element.

### Example 22, Comparative Example 12

A gallium nitride (GaN)-based semiconductor light-emitting element having a peak wavelength at 435 nm was used as the light-emitting element. Here, 2(Sr_{0.90}Ba_{0.07}Ca_{0.01}Eu_{0.02})O.SiO₂ and (Ca_{0.985}Eu_{0.115})(Al_{0.99}In_{0.01})SiN₃ were used as the yellow light-emitting phosphor and the red light-emitting phosphor respectively, to fabricate the wavelength conversion portion. Mixture of the yellow light-emitting phosphor and the red light-emitting phosphor at a prescribed ratio was diffused in an epoxy resin, followed by forming, thereby fabricating the wavelength conversion portion. The light-emitting device of Example 22 structured as shown in FIG. 2 was thus fabricated.

The light-emitting device according to Comparative Example 12 was fabricated as in Example 22, except for employing a gallium nitride (GaN)-based semiconductor light-emitting element having a peak wavelength at 460 nm as the light-emitting element, and using a yellow light-emitting phosphor expressed as (Y_{0.45}Gd_{0.42}Ce_{0.13})₃Al₅O₁₂.

Table 15 shows the result of evaluation of brightness and Tc-duv of Example 22 and Comparative Example 12.

TABLE 15

| | Brightness | |
|---|---|---|
| | (Relative Value (%)) | Tc-duv |
| Example 22 | 86.9 | 2900 K + 0.003 |
| Comparative | 100.0 | 2900 K + 0.050 |
| Example 12 | | |

As can clearly be seen from Table 15, in the light-emitting device according to Example 22 as well, non-yellowish, clear white light was obtained, as compared with Comparative Example 12 corresponding to a conventional product.

### Examples 23 and 24

A gallium nitride (GaN)-based semiconductor having a peak wavelength at 380 nm was used as the light-emitting element. (Ba_{0.50} Sr_{0.35}Eu_{0.15})MgAl₁₀O₁₇, 2(Sr_{0.900}Ba_{0.075}Ca_{0.010}Eu_{0.015})O.SiO₂, and (Ca_{0.97}Sr_{0.01}Eu_{0.02})(Al_{0.98}Ga_{0.02})SiN₃ were used as the blue light-emitting phosphor, the yellow light-emitting phosphor, and the red light-emitting phosphor respectively, to fabricate the wavelength conversion portion. In fabricating the wavelength conversion portion, initially, the red light-emitting phosphor layer was formed, and the yellow light-emitting phosphor layer was formed thereon. In addition, the blue light-emitting phosphor layer was formed on the yellow light-emitting phosphor layer. This wavelength conversion portion was used to fabricate the light-emitting device according to Example 23 structured as shown in FIG. 4.

The light-emitting device according to Example 24 structured as shown in FIG. 2 was fabricated as in Example 23, except for mixing the yellow light-emitting phosphor and the red light-emitting phosphor to fabricate a one-layered wavelength conversion portion.

Table 16 shows the result of evaluation of brightness and Tc-duv of Examples 23 and 24.

TABLE 16

| | Brightness | |
|---|---|---|
| | (Relative Value (%)) | Tc-duv |
| Example 23 | 117.5 | 2800 K + 0.001 |
| Example 24 | 100.0 | 2800 K + 0.001 |

As can clearly be seen from Table 16, in the light-emitting device according to Example 23, non-yellowish, clear white light was obtained. As can clearly be seen from comparison with Example 24, brightness of the light-emitting device was significantly improved by layering resin layers, sequentially from a layer containing a phosphor having a longer wavelength of the secondary light, from the side of the light-emitting element.

### Examples 25 to 30, Comparative Examples 13 to 18

The light-emitting device was fabricated using the method the same as in Example 1, and Table 17 shows the result of evaluation of various properties.

TABLE 17

| | Light- | | Brightness | |
|---|---|---|---|---|
| | Emitting | | (Relative | |
| | Element | Phosphor | Value)(%) | Tc-duv |
| Example 25 | 480 nm | Red: (Ca_{0.98}Eu_{0.02})AlSiN₃ | 85.1 | 2500 K + 0.002 |
| | | Yellow: 2(Sr_{0.91}Ba_{0.05}Ca_{0.02}Eu_{0.02})O.SiO₂ | | |
| Comparative | 465 nm | (Y_{0.55}Gd_{0.30}Ce_{0.15})₃Al₅O₁₂ | 100.0 | 2500 K + 0.060 |
| Example 13 | | | | |
| Example 26 | 440 nm | Red: (Ca_{0.98}Mg_{0.01}Eu_{0.01})(Al_{0.99}Ga_{0.01})SiN₃ | 87.5 | 3500 K + 0.003 |
| | | Yellow: 2(Sr_{0.90}Ba_{0.07}Eu_{0.03})O.SiO₂ | | |
| Comparative | 450 nm | (Y_{0.50}Gd_{0.35}Ce_{0.15})₃Al₅O₁₂ | 100.0 | 3500 K + 0.050 |
| Example 14 | | | | |
| Example 27 | 450 nm | Red: (Ca_{0.985}Eu_{0.015})AlSiN₃ | 86.0 | 2650 K + 0.002 |
| | | Yellow: 2(Sr_{0.85}Ba_{0.12}Ca_{0.01}Eu_{0.02})O.SiO₂ | | |
| Comparative | 460 nm | (Y_{0.50}Gd_{0.35}Ce_{0.15})₃Al₅O₁₂ | 100.0 | 2650 K + 0.060 |
| Example 15 | | | | |
| Example 28 | 445 nm | Red: (Ca_{0.98}Eu_{0.02})AlSiN₃ | 87.7 | 4000 K + 0.002 |
| | | Yellow: 2(Sr_{0.88}Ba_{0.10}Eu_{0.02})O.SiO₂ | | |
| Comparative | 460 nm | (Y_{0.45}Gd_{0.40}Ce_{0.15})₃Al₅O₁₂ | 100.0 | 4000 K + 0.045 |
| Example 16 | | | | |
| Example 29 | 400 nm | Red: (Ca_{0.98}Eu_{0.02})(Al_{0.99}Ga_{0.01})SiN₃ | 87.4 | 3100 K + 0.001 |
| | | Yellow: 2(Sr_{0.85}Ba_{0.13}Eu_{0.02})O.SiO₂ | | |
| | | Blue: (Sr_{0.74}Ba_{0.20}Ca_{0.05}Eu_{0.01})₁₀(PO₄)₆.Cl₂ | | |
| Comparative | 460 nm | (Y_{0.45}Gd_{0.40}Ce_{0.15})₃Al₅O₁₂ | 100.0 | 3100 K + 0.055 |
| Example 17 | | | | |
| Example 30 | 420 nm | Red: (Ca_{0.985}Eu_{0.015})AlSiN₃ | 87.9 | 3300 K + 0.002 |
| | | Yellow: 2(Sr_{0.85}Ba_{0.12}Ca_{0.01}Eu_{0.02})O.SiO₂ | | |
| | | Blue: (Ba_{0.40}Sr_{0.40}Eu_{0.20})(Mg_{0.99}Mn_{0.01})Al₁₀O₁₇ | | |
| Comparative | 450 nm | (Y_{0.50}Gd_{0.35}Ce_{0.15})₃Al₅O₁₂ | 100.0 | 3300 K + 0.050 |
| Example 18 | | | | |

As can clearly be seen from Table 17, in the light-emitting devices according to Examples 25 to 30 of the present invention, non-yellowish, clear white light was obtained, as compared with Comparative Examples 13 to 18 corresponding to a conventional product.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A light-emitting device comprising:
a light-emitting element emitting primary light; and
a wavelength conversion portion including a plurality of green or yellow light-emitting phosphors and a plurality of red light-emitting phosphors, and absorbing a part of said primary light and emitting secondary light having a wavelength equal to or longer than wavelength of the primary light; wherein
said green or yellow light-emitting phosphor is implemented by at least one selected from a europium (II)-activated silicate phosphor substantially expressed as General Formula (A-1): 2(MI₁₋ₐEuₐ)O.SiO₂ (in General Formula (A-1), MI represents at least one element selected from among Mg, Ca, Sr, and Ba, and relation of 0.005≦a≦0.10 is satisfied) and a cerium (III)-activated silicate phosphor substantially expressed as General Formula (A-2): MII₃(MIII_{1-b}Ce_{b})₂(SiO₄)₃ (in General Formula (A-2), MII represents at least one element selected from among Mg, Ca, Sr, and Ba, MIII represents at least one element selected from among Al, Ga, In, Sc, Y, La, Gd, and Lu, and relation of 0.005≦b≦0.5 is satisfied), and
said red light-emitting phosphor is implemented by a europium (II)-activated nitride phosphor substantially expressed as General Formula (B): (MIV_{1-c}Eu_{c})MVSiN₃ (in General Formula (B), MIV represents at least one element selected from among Mg, Ca, Sr, and Ba, MV represents at least one element selected from among Al, Ga, In, Sc, Y, La, Gd, and Lu, and relation of 0.001≦c≦0.05 is satisfied).

2. The light-emitting device according to claim 1, wherein
said light-emitting element is implemented by a gallium nitride (GaN)-based semiconductor emitting the primary light having a peak wavelength in a range from 430 nm to 480 nm.

3. The light-emitting device according to claim 1, wherein
said europium (II)-activated nitride phosphor, in which MV in General Formula (B) is at least one element selected from among Al, Ga and In, is used as said red light-emitting phosphor.

4. The light-emitting device according to claim 1, wherein
said europium (II)-activated silicate phosphor and said cerium (III)-activated silicate phosphor serve as the green light-emitting phosphor,
the green light-emitting phosphor composed of the europium (II)-activated silicate is such that NE in General Formula (A-1) includes at least Ba and relation of Ba≧0.5 is satisfied.

5. The light-emitting device according to claim 1, wherein
the green light-emitting phosphor composed of the cerium (III)-activated silicate substantially expressed in General Formula (A-2) is used as said green or yellow light-emitting phosphor.

6. The light-emitting device according to claim 5, wherein
MII in General Formula (A-2) is at least one element selected from Mg and Ca.

7. The light-emitting device according to claim 4, wherein
the primary light emitted by the light-emitting element has a peak wavelength in a range from 460 nm to 480 nm.

8. The light-emitting device according to claim 4, attaining correlated color temperature in a range from 5700K to 7100K, general color rendering index of at least 90, and special color rendering indices R9 to R₅ of at least 90.

9. The light-emitting device according to claim 4, attaining correlated color temperature in a range from 4600K to 5400K, general color rendering index of at least 90, and special color rendering indices R9 to R15 of at least 90.

10. The light-emitting device according to claim 1, wherein
the yellow light-emitting phosphor composed of the europium (II)-activated silicate, in which MI in General Formula (A-1) includes at least Sr and relation of Sr≧0.5 is satisfied, is used as said green or yellow light-emitting phosphor.

11. The light-emitting device according to claim 10, emitting white light at a correlated color temperature of at most 4000K.

12. A light-emitting device comprising:
a light-emitting element emitting primary light; and
a wavelength conversion portion including a plurality of green or yellow light-emitting phosphors, a plurality of red light-emitting phosphors and a plurality of blue light-emitting phosphors, and absorbing a part of said primary light and emitting secondary light having a wavelength equal to or longer than wavelength of the primary light; wherein
said green or yellow light-emitting phosphor is implemented by at least one selected from a europium (II)-activated silicate phosphor substantially expressed as General Formula (A-1): 2(MI₁₋ₐEuₐ)O.SiO₂ (in General Formula (A-1), MI represents at least one element selected from among Mg, Ca, Sr, and Ba, and relation of 0.005≦a≦0.10 is satisfied) and a cerium (III)-activated silicate phosphor substantially expressed as General Formula (A-2): MII₃(MIII_{1-b}Ce_{b})₂(SiO₄)₃ (in General Formula (A-2), MII represents at least one element selected from among Mg, Ca, Sr, and Ba, MIII represents at least one element selected from among Al, Ga, In, Sc, Y, La, Gd, and Lu, and relation of 0.005≦b≦0.5 is satisfied),
said red light-emitting phosphor is implemented by a europium (II)-activated nitride phosphor substantially expressed as General Formula (B): (MIV_{1-c}Eu_{c})MVSiN₃ (in General Formula (B), MIV represents at least one element selected from among Mg, Ca, Sr, and Ba, MV represents at least one element selected from among Al, Ga, In, Sc, Y, La, Gd, and Lu, and relation of 0.001≦c≦0.05 is satisfied), and
said blue light-emitting phosphor is implemented by at least one selected from a europium (II)-activated halophosphate phosphor substantially expressed as General Formula (C-1): (MVI,Eu)₁₀(PO₄)₆.Cl₂ (in General Formula (C-1), MVI represents at least one element selected from among Mg, Ca, Sr, and Ba), a europium (II)-activated aluminate phosphor substantially expressed as General Formula (C-2): d(MVII,Eu)O.eAl₂O₃ (in General Formula (C-2), MVII represents at least one element selected from among Mg, Ca, Sr, Ba, and Zn, and relation of d>0, e>0 and 0.1≦d/e≦1.0 is satisfied), and a europium (II)- and manganese-activated aluminate phosphor substantially expressed as General Formula (C-3): f(MVII,Euₕ,Mnᵢ)O.gAl₂O₃ (in General Formula (C-3), MVII represents at least one element selected from among Mg, Ca, Sr, Ba, and Zn, and relation of f>0, g>0, 0.1≦f/g≦1.0, and 0.001≦i/h≦0.2 is satisfied).

13. The light-emitting device according to claim 12, wherein
said light-emitting element is implemented by a gallium nitride (GaN)-based semiconductor emitting the primary light having a peak wavelength in a range from 380 nm to 430 nm.

14. The light-emitting device according to claim 12, wherein
said europium (II)-activated nitride phosphor, in which MV in General Formula (B) is at least one element selected from among Al, Ga and In, is used as said red light-emitting phosphor.

15. The light-emitting device according to claim 12, wherein
said europium (II)-activated silicate phosphor and said cerium (III)-activated silicate phosphor serve as the green light-emitting phosphor,
the green light-emitting phosphor composed of the europium (II)-activated silicate is such that MI in General Formula (A-1) includes at least Ba and relation of Ba≧0.5 is satisfied.

16. The light-emitting device according to claim 12, wherein
the green light-emitting phosphor composed of the cerium (III)-activated silicate substantially expressed in General Formula (A-2) is used as said green or yellow light-emitting phosphor.

17. The light-emitting device according to claim 16, wherein
MII in General Formula (A-2) is at least one element selected from Mg and Ca.

18. The light-emitting device according to claim 12, wherein
the europium (II)-activated halophosphate phosphor substantially expressed as General Formula (C-1) having an emission peak wavelength in a range from 460 to 480 nm is used as said blue light-emitting phosphor.

19. The light-emitting device according to claim 15, attaining correlated color temperature in a range from 5700K to 7100K, general color rendering index of at least 90, and special color rendering indices R9 to R15 of at least 90.

20. The light-emitting device according to claim 15, attaining correlated color temperature in a range from 4600K to 5400K, general color rendering index of at least 90, and special color rendering indices R9 to R15 of at least 90.

21. The light-emitting device according to claim 12, wherein
the yellow light-emitting phosphor composed of the europium (II)-activated silicate, in which MI in General Formula (A-1) includes at least Sr and relation of Sr≧0.5 is satisfied, is used as said green or yellow light-emitting phosphor.

22. The light-emitting device according to claim 21, emitting white light at a correlated color temperature of at most 4000K.
